(19) United States
(12) Patent Application Publication
(10) Pub. No.: US 2007/0234058 A1
(43) Pub. Date: Oct. 4, 2007

(54) SYSTEM AND METHOD FOR AUTHENTICATING PRODUCTS

(76) Inventor: Charles A. White, Oakland, CA (US)

Correspondence Address: WILLIAM J. KOLEGRAFF;KESTREL WIRELESS, INC., 15050 AVENUE OF SCIENCE, STE. 230, SAN DIEGO, CA, 92128, US

(21) Appl. No.: 11/556,958

(22) Filed: Nov. 6, 2006

Related U.S. Application Data
(60) Provisional application No. 60/733,716, filed on Nov. 4, 2005.

(51) Int. Cl. H04L 9/00

(52) U.S. Cl. 713/176

(57) ABSTRACT

A method of authenticating a product is provided. The product has an associated electronic device, such as an RFID circuit. The method measures a physical attribute of the product, such as a laser speckle, and stores the measurement as a product signature, either in the RFID circuit or remotely. At the time the product is to be authenticated, a second measurement is taken, which is compared to the product signature. A product identifier from the electronic device may be used to facilitate the comparison. If the signatures match, the product is considered to be authentic.

### RELATED APPLICATIONS

This application claims priority to U.S. patent application Ser. No. 60/733,716, filed Nov. 4, 2005, and entitled “System and Method for Authenticating Products”, which is incorporated herein in its entirety.

### BACKGROUND

### Related Technology

Knowing the authenticity of products is a critical problem. Counterfeit or fake pharmaceuticals, consumer electronics, industrial components, optical media, documents, currency, gemstones, stamps, books, photographs and works of art etc., are widespread. This results not only in loss of revenue to the authentic manufacturers, but also in potential risks to individual health, in the case of counterfeit pharmaceuticals and heightened risk of accidents in the case of counterfeit airplane components.

There are many methods that are used today, such as hard to replicate labels or holograms, to differentiate real from counterfeit products. All of these methods simply raise the investment required to make a counterfeit. However, in the case of many products the economic motivation is sufficient to overcome this barrier and the products are counterfeited. In addition, it is often difficult for law enforcement to rapidly and reliably identify a counterfeit product, which ultimately limits their ability to prosecute offenders.

Various methods have been developed for assigning a unique identifier to a product. One such method makes use of the optical phenomenon of laser speckle to measure the inherent roughness of different surfaces and constructs a unique signature from this surface characteristic [James D. R. Buchanan, Russell P. Cowburn, Ana-Vanessa Jausovec, Dorothee Petit, Peter Seem, Gang Xiong, Del Atkinson, Kate Fenton, Dan A. Allwood and Matthew T. Bryan, “Forgery: ‘Fingerprinting’ documents and packaging,” Nature, 436:475 (Jul. 28, 2005); see also International Application Nos. WO 2005/088517 and WO 2005/088533]. There is no known manufacturing process that is capable of copying these surface imperfections at a level of precision to replicate the signature. As a result, this signature (a “product signature”) can uniquely identify an object.

### SUMMARY

In many applications, for a product signature to be useful in authenticating a product, however, it needs to be incorporated into an authentication service that functions as a trustee that connects and intermediates between the various parties involved in authenticating a product. The present methods meet this need by providing a method for authenticating a product by:

(a) providing a database comprising product signature data for the product and product identifier data, the product signature data is associated in the database with at least one product identifier;

(b) measuring a physical attribute of the product to determine a product signature for the product;

(c) obtaining product identifier data from an electronic device associated with the product;

(d) comparing the product signature for the product and the product identifier from the electronic device with product signature data and product identifier data in the database; and

(e) determining whether the product identifier from the electronic device matches product identifier data in the database associated with the product signature for the product.

The product signature and product identifier from the electronic device associated with the product are preferably obtained with an authentication device that reads the product signature, obtains the product identifier, sends the product signature and product identifier to a remote authentication service, and delivers an indication to a user of the device as to the products authenticity. Alternatively, such a device can authenticate the product signature and product identifier locally. The electronic device includes a processor with memory, and in one embodiment is embedded in the product. The product signature is preferably a laser speckle measurement of a surface of the product, and the electronic device is preferably an RFID tag. The product itself can be a label, a credit card, paper currency, paper packaging, a document, optical media, or an RFID tag. Examples of documents include a loan document, an insurance document, and a document associated with a payment. In the present methods, step (d) can comprise sending the product signature for the product and the product identifier data from the electronic device to a remote server. If the product identifier data from the electronic device comprises an encrypted token, step (d) can also comprise decrypting the encrypted token, which can be an encrypted version of the product signature.

Alternatively, the product identifier data can comprise a copy of the product signature encoded using a private key of a public/private key pair which is stored on the RFID tag. The reader can compare the product signature with a decrypted version of the stored signature using the corresponding public key. If the two match, then the product is deemed to be authentic. In this embodiment, the decryption of the product signature can optionally be performed locally by the reader without needing to access a database.

Preferably, the present method includes the step of communicating an authentication signal when the product identifier from the electronic device is determined to match product identifier data in the database associated with the product signature for the product. The methods can also further comprise the step of performing a financial settlement following receipt of the authentication signal.

In another aspect, the present invention comprises an electronic device comprising a memory and a communications interface. The device has a measurable physical attribute, such as a surface pattern detectable by laser speckle, and the memory comprises data indicative of the measurable physical attribute, such as a laser speckle measurement of a surface of the device. The data is preferably encrypted.

### DRAWINGS

These and other features, aspects and advantages of the present invention will become better understood with regard to the following description, appended claims, and accompanying figures where:

FIG. 1 is a diagram illustrating the steps performed in authenticating a product in one embodiment of the present methods.

FIG. 2 is a diagram illustrating the steps performed in loading a processor in one embodiment of the present methods.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use.

### DESCRIPTION

Definitions

As used herein, the following terms and variations thereof have the meanings given below, unless a different meaning is clearly intended by the context in which such term is used.

“Processor” refers to an electronic device with data processing capabilities, including data storage and the ability to communicate with other devices (i.e. readers). Such communication is also preferably wireless, such as via radio frequency or other electromagnetic signals. When processors are used with products they are preferably attached to, embedded in, or otherwise associated with such products.

“Product” refers to an article, item or media, and can be in particular a label or RFID tag.

“Product signature” refers to a unique identifier of a product, in particular a measurable physical attribute of a product such as a laser speckle pattern of the surface of a product.

“Reader” refers to a device which obtains a product signature of a product and/or a product ID from a processor. Preferably, a reader provides an input signal, preferably an electromagnetic signal, to a processor associated with a product. If the processor emits an electromagnetic signal in response, the reader is preferably configured to receive and process such signal. Readers are also preferably configured to communicate with databases located remotely with respect to the reader and product.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

Authentication

The systems, methods and means described herein make use of a product signature that can be used to authenticate a diverse array of product types. Although principally referring to unique product signatures, the term product signature should be also understood to include product signatures that are not necessarily unique, but that would be difficult if not practically impossible to duplicate.

Product signatures are employed in the present methods together with an authentication service. An authentication service for example can enable unrelated parties to authenticate products (e.g., a consumer electronics manufacturer and a customs agent, or a pharmaceutical company and a consumer). An authentication service can also enable parties to authenticate products over a variety of communication means (e.g., Internet, mobile phones) and locations (retail point-of-sale, inspection/customs centers, home etc.). An authentication service can also enable authentication dependent transactions and services such as payments, loans or insurance.

A product signature is “read” directly from a product (e.g. via laser speckle) and published to an authentication service database where it is stored. The authentication service database typically resides at an authentication service center. The party publishing the product signature can be a manufacturer, distributor, retailer, 3rd party service, consumer or other entity (collectively referred to herein as a “publisher”). Depending on the specific circumstances, a product can be coupled to, or integrated into a secondary item. For example a label (the product) can be permanently adhered to a bottle (the secondary item). The result of reading the product signature of the product can be transmitted or stored in its original form or transformed into any number of analog or digital formats.

The authentication service database can be hosted by the publisher, but it is typically hosted by a separate party, an authentication service provider (“ASP”). When a party (“user”) wants to authenticate a product, the product signature is again read directly from the product with a reader. This second read is typically executed by the user or a related party (e.g. a retailer reading a credit card). The result of the second read, the product signature, is then compared to product signatures previously stored in the authentication service database and, conditional on associated decision rules and variables, the appropriate response is communicated back to the user.

The product signature can be associated with one or more product identifiers (“product ID”) such as a serial number or product code which can be physically coupled to, or integrated into the product. The product ID is also preferably published to the authentication service database. The product ID need not be unique. For example, a pharmaceutical package (the product from which the product signature is read) can have a label imprinted with a serial number (the product ID) adhered to its surface. Another example would be the label itself, in this example the product from which the product signature is read, imprinted with a bar code (product ID) and attached to a pharmaceutical package. Another example would be a serial number stamped into a machined part. In each example the product signature is associated with a product ID. Note that the product ID can be associated with one or more product signatures. In either case, the product ID can be used to simplify the authentication process by allowing the ASP to identify the product signature, or group of product signatures stored in its database to which the product signature received from the user is compared.

The product signature can also be associated with one or more informative elements (“IE”) which comprise information about the product. The IE can be inherent in the product (e.g. a description of the product) or complementary to it; e.g., a label describing the contents stored within a package (the product). This information (i.e. text or images) can be used in certain circumstances to provide varying degrees of assurance that an item associated with an authenticated product is not counterfeit or otherwise not as intended or expected. An IE can be published to an authentication service database by the publisher or a 3rd party and later provided by an authentication service provider to a user attempting to authenticate the product or its contents.

A user of a product, for example, can obtain some degree of assurance that the contents of a package (product) were authentic if the descriptive information received by the user from an ASP in response to a read of the product by the user described the package, and if the user can further ascertain that the package has not been tampered with (e.g. visual inspecting a seal to see if it is broken). A practical application of such a system would be for consumers to obtain a degree of assurance that products (e.g. factory sealed pharmaceuticals) purchased over the internet are not counterfeit. Another application would be to provide a degree of assurance that an authenticated label (in this instance the product) has not been removed from its original package and applied to a substitute package.

Another application would for a user (e.g. a field inspector) to receive a copy of a number (the IE) stamped into the product (e.g. an aircraft part) and published to the authentication service database (e.g. by an independent testing laboratory) that can be used to assure that the product had been properly tested prior to installation.

In some instances a higher degree of assurance can be obtained if the number of requests for authentication or the number of authentications provided is known or restricted. For example, if a user knows that they are the only party to have authenticated a particular (unique) product or product ID, and that they can associate the information received from the ASP with the product in their possession (or an item coupled to the product), then the user can obtain some degree of assurance that the product (or the item to which it is coupled) is authentic.

At the time of manufacture or at some time prior to entering the distribution chain, a unique product ID can be assigned to a product. This can be, for example, an electronic ID stored in an RFID tag or a UPC identifier stored in bar code form. In addition, at this time a reader can read the unique surface characteristics of the product and, in one embodiment, construct an encoded representation of those characteristics to serve as the unique product signature. If an RFID tag is physically associated with the product (such as by being attached to or embedded in the product), the product ID can be stored in the tag. Both the product ID and the product signature are stored in an authentication database, which can be stored on a server at a location which is remote with respect to the location of the product. This database is then made accessible through an authentication service provider. In one embodiment, the product ID on such a tag is encrypted, in order to assure that the tag itself is authentic and not a counterfeit.

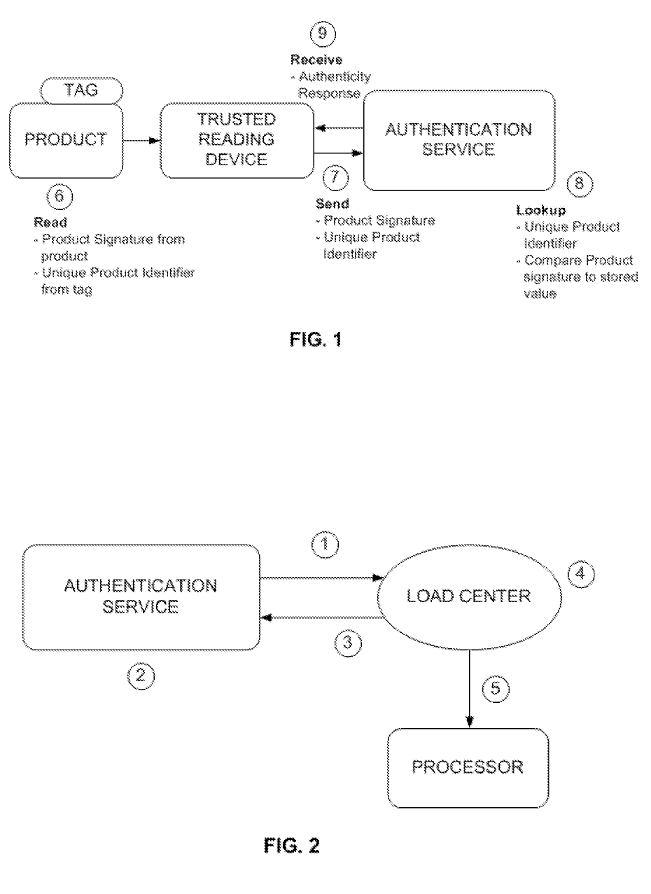

As illustrated in FIG. 1, at the time at which the authenticity of a product needs to be verified, a reader (the “trusted” reading device) reads the product signature and the product ID, which can be stored in an RFID tag (step 6). This reader then sends both identifiers to the ASP (step 7), such as via a direct or networked connection. This reader should be trusted by the user, that is, the user should be confident that the reader is making use of a valid ASP and is correctly representing the result of an authentication query.

The ASP uses the product ID to look up the product signature that has previously been read and associated with it (step 8). If the product signature matches, the ASP sends a positive response to the reader (step 9). If it does not, the ASP sends a response indicating that the product cannot be authenticated. The reader can then either be programmed to take a series of actions or an operator can be notified and can take action based on the result. In the present methods, an IE can be read in addition to or instead of the product ID.

In another implementation, at the point of manufacture or at some time prior to entering the distribution chain, an encrypted version of the product signature is stored on a processor associated with a product, such as an RFID tag, either in addition to or in place of the product ID stored on the tag. The tag passes the encrypted version of the signature and a key identifier to the reader, which in some embodiments forwards it to an authentication service. The authentication service uses the key identifier to determine the appropriate private key with which to decrypt the encrypted signature. The authentication service decrypts the signature and passes that back to the reader. The reader then compares the decrypted signature to the one that it reads off of the product. If they are the same (i.e., if the detected product signature and the decrypted product signature differ from each other by less than a predetermined amount or in only a predetermined manner), the reader can make the determination that the product is authentic. In this way there is no requirement for the authentication service to maintain a database of all products. It simply maintains a list of private keys that are used to decrypt the signature. All or part of this database can be replicated to a distributed set of authentication sites as required by the specific application. This replication database can itself be encrypted for security purposes using keys known to the authentication service and the distributed authentication site.

In another implementation, at the point of manufacture or at some time prior to entering the distribution chain, a version of the product signature encrypted using the private key of a public/private key pair is stored on such tag, either in addition to or in place of the product ID stored on the tag. The tag passes the encrypted version of the signature and a key identifier to the reader. The reader uses the corresponding public key to decrypt the encrypted signature. The reader then compares the decrypted signature to the one that it reads off of the product. If they are the same (i.e., if the detected product signature and the decrypted product signature differ from each other by less than a predetermined amount or in only a predetermined manner), the reader can make the determination that the product is authentic. In this way the authentication service can be performed locally and without reference to an external service or database.

In an alternative embodiment, the present methods can be mediated by a human and support authentication situations in which there is no computer network connection to an authentication service. In this embodiment, the encrypted signature or product ID (each a “token”) can be provided as part of the packaging for a product having a processor or can be encoded in a visual form on the product itself. An authorized individual can then provide this information over a telephone in conversation with an authentication service.

The authentication service can authenticate this individual using any number of methods. The individual can be, for example, a retail merchant employee who has been provided a merchant password for use during periods of network outage. Alternatively, a device at the authentication location that has been constructed to perform the authentication function without network access can provide its encrypted certificate to the individual and the individual can then provide this to the authentication service.

The present system can also support pre-caching of tokens to support the requirement for local authentication of products in the event of a network or system failure that prevents access to a remote activation service. In this process, the local system would perform the first steps of an authentication transaction. The local system would take the encrypted token from the processor, pass it to the authentication service, and receive the decrypted token back. These decrypted tokens can then be stored in a local database and used by the local system to authenticate the product without a requirement for communicating with a remote service in real time. This approach using a local decrypted token store can be used as a backup service or alternatively can be used as the primary service with the network activation service providing a backup.

To speed throughput of the system it is also possible for information to be read from multiple products at the same time, and to then send the related transaction information to a central service (e.g., an ASP) in a single transaction. The central service can then provide the associated tokens back to the local system (e.g., a point of sale) in a single response. This approach can reduce the total latency time associated with activation processing. Alternatively, this transaction aggregation can occur across multiple local terminals. In this case there would be a periodic block of activation transactions sent to the authentication service. This period could be varied based upon the amount of local activity while ensuring that the latency time for any given transaction is minimized.

This basic system enables a variety of authentication applications. The service can be used by companies and consumers to ensure that they are purchasing an authentic product. It can be used by product manufacturers to reduce or eliminate the opportunity for counterfeit. In addition, the reader operator can be policing the counterfeiting of, e.g., optical media. If the operator finds a distributor selling product that is not authentic, he can take appropriate action. This ability enables police to enforce intellectual property laws and reduce of the impact of counterfeit products in the market.

The system can also support a variety of mobile or fixed readers that can vary depending on the nature of the user and the specific application. For example, it would be possible to integrate a label reader, product signature reader and phone that can be used by consumers to validate any participating item. Another example would be to integrate a product signature scanner into a retail point-of-sale UPC scanner. Another example would be a warehouse scanner that would be used to determine the authenticity of products coming into a loading dock.

The breadth of items that can be authenticated is extensive. Items that can benefit from this system range from consumer electronics, optical media, credit cards, and pharmaceuticals, to currencies. In the case of currencies, a signature can be constructed by imaging each bill with its serial number becoming its unique ID. These can be read by a device at a merchant location, a bank or a device under a consumer's control to validate that a specific bill was not counterfeit. The same process also works to authenticate documents.

In another embodiment, the present methods comprise a method for performing financial settlements among parties involved in trading a product, based on authenticated products or on information derived from authenticated products, by correlating authenticated products to financial products and then using these financial products to determine a financial settlement (transfer of funds) among trading parties. The settlement can involve, for example, the transfer of funds from a distributor to a product manufacturer; the transfer of funds from a product purchaser to a network operations center and then from the network operations center to trading partners; the transfer of funds from a product purchaser to a product wholesaler; or the transfer of funds from a product manufacturer to a distributor. The settlement can be performed as transactions occur or at regular intervals determined by time or product sales volumes. In an alternative embodiment, rather than transferring funds to settle a transaction, the present methods can be used to transfer ownership of a product among trading parties, based upon authenticated products or information derived from authenticated products. A network operations center preferably also maintains a supply chain database of parties involved in the distribution of products.

Applications can be built using the present methods to guarantee authenticity for items that might be difficult to scan directly, such as pharmaceuticals. One approach would be to create unique tags that cannot be counterfeited by constructing a product signature from the tag, for example a laser speckle pattern of a surface of the tag, rather than from the product. These unique tags can be placed on products and then scanned as appropriate. While the authentication is of the tag and not the product, for many applications this is sufficient.

In addition, such a system can be used as a basis for implementing other services tied to specific products. Products that have expiration dates or warranty information can have that information returned, for example by the ASP, as part of an authentication exchange. Similarly, financial and insurance services and products can be tied to product authentications. This system can also be used to support the distribution of secure access tokens. A piece of paper or a piece of cardboard would have a unique signature that can be used as an access token, eliminating the opportunity for that token to be copied.

This system thus provides a number of benefits. It can help eliminate counterfeits in a wide variety of product categories by linking a unique and verifiable physical attribute with a unique ID in the context of an authentication system. It supports multiple methods of generating unique signatures and supports multiple methods for storing a unique ID with a product. In addition, it supports authentication from anywhere.

Determining a Product Signature

The principal optical components of a system for determining a product signature based on laser speckle are a laser source for generating a coherent laser beam and a detector arrangement made up of a plurality of k photodetector elements, where k can be, for example, 4. The laser beam is focused by a cylindrical lens into an elongate focus extending in the y direction (perpendicular to the plane of the product). In an example prototype, the elongate focus has a major axis dimension of about 2 mm and a minor axis dimension of about 40 micrometers. These optical components are preferably contained in a mounting block. The photodetector elements can be distributed on either side of the beam axis offset at different angles in an interdigitated arrangement from the beam axis to collect light scattered in reflection from an article present in the reading volume. In an example prototype, the offset angles are −70, −20, +30 and +50 degrees.

Light access to the photodetector elements is provided by through holes in the mounting block. The angles either side of the beam axis are chosen so as not to be equal so that the data points they collect are as independent as possible. All photodetector elements are preferably arranged in a common plane. The photodetector elements detect light scattered from the surface of the product being conveyed past the scan head when the coherent beam scatters from the product. The source can be mounted to direct the laser beam with its beam axis in the z direction, so that it will strike the product at normal incidence.

Generally it is desirable that the depth of focus is large, so that any differences in the product positioning in the z direction do not result in significant changes in the size of the beam incident on the product. In an example prototype, the depth of focus is approximately 0.5 mm which is sufficiently large to produce good results. The parameters, of depth of focus, numerical aperture and working distance are interdependent, resulting in a well known trade off between spot size and depth of focus.

When the product is paper and the scan head is integrated into an otherwise conventional printer, the paper feed mechanism will serve to move the product linearly in the x direction past the scan head so that the beam is scanned in a direction transverse to the major axis of the elongate focus. Since the coherent beam is dimensioned at its focus to have a cross-section in the xz plane that is much smaller than a projection of the reading volume in a plane normal to the coherent beam, i.e. in the plane of the product, the product feed will cause the coherent beam to sample many different parts of the product.

With a minor dimension of the focus of 40 micrometers and a scan length in the x direction of 2 cm, for example, n=500, giving 2000 data points with k=4. A typical range of values for k×n depending on desired security level, article type, number of detector channels ‘k’ and other factors is expected to be 100<k×n<10,000. It has also been found that increasing the number of detectors k also improves the insensitivity of the measurements to surface degradation of the article through handling, printing etc. In practice, with the prototypes used to date, a rule of thumb is that the total number of independent data points, i.e. k×n, should be 500 or more to give an acceptably high security level with a wide variety of surfaces.

Loading Process

The process of loading an RFID tag or other processor with a product ID and/or with an encrypted version of a product signature (both referred to in the following discussion as a “token”) can be as illustrated in FIG. 2. In this embodiment, a load center application (i.e., the application that loads data onto the processor) requests a public key (1) for use in encrypting a token for the processor. The authentication service center then determines the appropriate public/private key pair to use for the encryption (2) and supplies the appropriate public key to the load center application (3). Alternatively, the load center can determine the public key pair and send the private key in a secure session to the authentication service center. In a further alternative, the load center can be authorized to use a specific key, in which case the load center does not need to communicate with the authentication service center at the time a processor is loaded.

In any event, at some point either prior to or during the loading process, the load application will be in secure communication with the authentication service center. This secure channel can be established using standard PKI certificates and session encryption methods, for example. Over this secure communication channel, the authentication service center and load center application will exchange the public key to be used to encrypt the token to be stored on the processor.

There can be one public/private key pair for the authentication service center or load center, or any number of key management algorithms can be used to vary the key pair as required by a particular application. It is only important that the authentication service center can determine the public key that was used to encrypt the token, so that it can use the corresponding private key for later communication with the processor. The public key generally will vary based on the key management policies used by the authentication service center. For example, encryption keys can be changed on a fixed time schedule, on a random time schedule, or on a schedule that is specific to the manufacturer but determined by the authentication service center. With regard to key management, all that is required for the method to operate is that there is a mapping known to the authentication service center between a specific processor and the public key used to encode the token for the processor. Of particular note, the load application does not need to know the key management scheme used at the authentication service center.

The load center application then generates a token and encrypts it using the public key supplied by (or to) the authentication service center (4). This token can have meaning or can be randomly generated.

The load application then stores an authentication block comprising the token and its encrypted version, along with any optional information, such as the current date and time, on the processor. Some of this information can be used to support a key management process. For example, the public/private key pair can vary by load center, by week. If this is the key management process used, then the processor must how the time that it was loaded so that the authentication service center can use this information to determine the appropriate private key to use for later communication with the processor. An alternative implementation would be for the load center to indicate to the authentication service center which processors by ID were loaded during a given period. The authentication service center can then use the processor ID in the determination of the appropriate key pair.

On the processor, the plaintext token optionally can be stored in memory that physically can only be compared in a register and cannot be read into main memory. This minimizes the ability of a third party to acquire the plaintext token and fraudulently provide it back to the processor.

### EXAMPLE 1

### Determining a Product Signature for a Piece of Paper

The scanner uses a 635 nm collimated laser diode which is focused to a line on the surface of the document using a cylindrical lens of focal length 16 mm. The focused line is approximately 70 nm wide and 4 mm long and has an average angle of incidence of zero, i.e. the optical axis is along the surface normal of the document. The laser and focusing optics are mounted on a linear motion drive which scans across the paper surface at a speed of 20 mm s⁻¹, in the direction parallel to the short axis of the focused laser line. Four silicon phototransistors gaze onto the focused line and measure the intensity of reflected light at angles of reflection of −50°, −20°, +30° and +60°. The −20° and +30° photodetectors are centered on the middle of the line, while the −50° and +60° photodetectors are offset (transverse to the direction of motion) from the middle of the line by ±1.5 mm respectively. The signals from the photodetectors are AC coupled and then amplified before being digitized by a microcontroller at a rate of approximately 500 samples per second. A signal from an optical position encoder is also digitized in order to compensate for fluctuations in the motor speed.

Although the present invention has been discussed in considerable detail with reference to certain preferred embodiments, other embodiments are possible. The steps disclosed for the present methods are not intended to be limiting nor are they intended to indicate that each step depicted is essential to the method, but instead are exemplary steps only. Therefore, the scope of the appended claims should not be limited to the description of preferred embodiments contained in this disclosure. All references cited herein are incorporated by reference to their entirety.

What is claimed is:

1. A method for authenticating a product, comprising:
storing a first product signature and a first product identifier for the product;
measuring a physical attribute of the product to determine a second product signature for the product;
obtaining a second product identifier from an electronic device associated with the product;
retrieving the first product signature;
comparing the first product signature to the second product signature; and
determining responsive to the comparison, whether the first product signature matches the second product signature.

2. The method according to claim 1, wherein the electronic device is an RFID circuit attached to the product, and the second product identifier is obtained by reading the second product identifier from the RFID circuit.

3. The method according to claim 1, wherein the electronic device is an RFID circuit attached to the product, and the step of retrieving the first product signature comprises reading the first product signature from the RFID circuit.

4. The method according to claim 1, wherein the electronic device is an RFID circuit attached to the product, and the step of retrieving the first product signature comprises reading an encrypted version of the first product signature from the RFID circuit.

5. The method according to claim 4, further including the step of decrypting the encrypted version of the first product signature using a key selected according to the second product identifier.

6. The method according to claim 1, wherein the second product identifier is used to indicate a decryption key.

7. The method according to claim 1, wherein the storing step comprises using a remote database.

8. The method according to claim 1, wherein the retrieving step comprises using a remote database.

9. The method according to claim 1, wherein the first product signature and the second product signature represent measured surface characteristics for the product.

10. The method according to claim 1, wherein the first product signature and the second product signature represent measured laser speckle for the product.

11. An authentication device, comprising:
An optical scanner for making a surface scan;
a wireless RF reader;
a processor operating the steps of:
using the optical scanner to generate a measured product signature for a product;
retrieving a stored product signature for the product;
comparing the measured product signature to the stored product signature; and
determining responsive to the comparison, whether the measured product signature matches the stored product signature; and
activating a local alert as to the authenticity of the product.

12. The authentication device according to claim 11, wherein the optical scanner is a laser.

13. The authentication device according to claim 11, wherein the surface scan is a laser speckle.

14. The authentication device according to claim 11, wherein the processor further operates the step of retrieving a stored product identifier from the product.

15. The authentication device according to claim 14, wherein the step of retrieving the product identifier comprises retrieving the product identifier using the wireless RF reader.

16. The authentication device according to claim 11, wherein the step of retrieving the stored product signature comprises retrieving the stored product signature using the wireless RF reader.

17. The authentication device according to claim 11, wherein the processor further operates the step of decrypting the stored product signature.

18. The authentication device according to claim 11, wherein the wireless RF reader is an RFID scanner.

19. An RFID circuit holding a product signature for a product, the product signature representing surface characteristics of the product.

20. The RFID circuit according to claim 19, wherein the product signature is a laser speckle.

21. The RFID circuit according to claim 19, wherein the RFID circuit is attached to the product.
